(19) United States
(12) Patent Application Publication
(10) Pub. No.: US 2015/0218374 A1
(43) Pub. Date: Aug. 6, 2015

(54) POLYAMIDE MOULDING COMPOUNDS WITH FLAME-RETARDANT PROPERTIES AND VERY GOOD LONG-TERM HEAT-AGEING RESISTANCE

(71) Applicant: EMS-PATENT AG, Domat/Ems (CH)

(72) Inventors: Oliver THOMAS, Domat/Ems (CH); Nikolai LAMBERTS, Bonaduz (CH); Botho HOFFMANN, Domat/Ems (CH); Georgi BESCHIASCHVILI, Chur (CH)

(21) Appl. No.: 14/607,676

(22) Filed: Jan. 28, 2015

(30) Foreign Application Priority Data
Jan. 31, 2014 (EP) 14 153 391.9

(51) Int. Cl. C08L 77/02; C08L 77/06

(52) U.S. Cl. CPC C08L 77/02; C08L 77/06; C08L 2205/025; C08L 2201/08; C08L 2201/02

(57) ABSTRACT

The present invention relates to polyamide moulding compounds which are distinguished by excellent flame-retardant properties and by very good long-term heat-ageing resistance. The moulding compounds according to the invention comprise a partially aromatic polyamide, caprolactam, a heat stabiliser, possibly a flame retardant and optionally further additives and admixtures. The polyamide moulding compound is thereby free of metal salts and/or metal oxides of a transition metal of group VB, VIB, VIIB or VIIIB of the periodic table.

### CROSS-REFERENCE TO A RELATED APPLICATION

This application claims the benefit of European Patent Application No. 14 153 391.9, filed Jan. 31, 2014, the disclosure of which is incorporated herein by reference.

The present invention relates to polyamide moulding compounds which are distinguished by excellent flame-retardant properties and by very good long-term heat-ageing resistance. The moulding compounds according to the invention comprise a partially aromatic polyamide, caprolactam, a heat stabiliser, possibly a flame retardant and optionally further additives and admixtures. The polyamide moulding compound is thereby free of metal salts and/or metal oxides of a transition metal of group VB, VIB, VIIB or VIIIB of the periodic table.

Thermoplastic polyamides can be used as construction materials for components which are subjected to increased temperatures during their lifespan. Since the result hereby is thermooxidative damage, heat stabilisers which delay the occurrence of thermooxidative damage are used.

Long-term heat-stabilised polyamide moulding compounds are known from EP 2 535 365 A1, in which moulding compounds based on a partially aromatic polyamide and caprolactam are processed, which moulding compounds are provided with copper stabilisers or with mixtures of copper- and/or organic stabilisers. These moulding compounds do not however have any flame-retardant effect.

Also WO2006/074934A1 relates to long-term heat-stabilised moulding compounds. The long-term heat stabilisation is achieved here by the use of at least two special heat stabilisers (e.g. copper iodide and iron oxide) and by the use of two polyamides which differ in melting point by at least 20° C.

WO2012/168442A1 describes long-term heat-stabilised moulding compounds which, in addition to a partially aromatic polyamide, also comprise PA 6 or PA 66, mixtures of copper stabilisers and elementary iron being used as heat stabiliser.

Basically, there is a market requirement for polyamides which are free of inorganic (halogenide-containing) salts, as a result of which they can be used for contact with electrically conducting parts or metallic parts at risk of corrosion, without causing contact corrosion. Salts in the polyamide can be washed out from the latter by water or other polar media. By enrichment on the surface, undesired electrically conducting paths can thus be formed, which in addition can lead to electrical short circuits.

In parallel, there is also a requirement for highly heat-stabilised (>220° C.) polyamides.

To date, the heat stabilisation of polyamides has been effected for high temperatures (>160° C.) in particular by stabilisation with copper iodide/potassium iodide, generally approx. 0.5% by weight, relative to the polymer matrix, being used. For lower temperatures up to approx. 160° C., in particular organic stabilisers are used. Typical contents of e.g. phenolic stabilisers are approx. 0.1-0.5% by weight, relative to the polymer matrix. For higher temperatures, this stabilisation according to the state of the art was not effective enough.

Starting from the previous state of the art, it was therefore the object of the present invention to provide a polyamide moulding compound which has very good long-term heat-ageing resistance without causing contact corrosion or conductive bridges.

This object is achieved by the polyamide moulding compound according to patent claim 1 and the moulded article according to claim 16. The dependent claims thereby represent advantageous embodiments.

According to the invention, a polyamide moulding compound is hence provided, consisting of

a) 22 to 99.99% by weight of a polyamide mixture, consisting of
(A1) at least one partially aromatic, partially crystalline polyamide with a melting point in the range of 255 to 330° C.,
(A2) at least one caprolactam-containing polyamide which differs from the at least one partially aromatic, partially crystalline polyamide (A1) and has a content of caprolactam of at least 50% by weight,
   the total caprolactam content of the caprolactam contained in polyamide (A1) and polyamide (A2), relative to the polyamide mixture, being 3 to 35% by weight,

b) 0 to 25% by weight of at least one flame retardant,

c) 0.01 to 3.0% by weight of at least one heat stabiliser based on sterically hindered phenols and

d) 0 to 50% by weight of at least one additive,

components a) to d) adding up to 100% by weight. The polyamide moulding compound is thereby free of metal salts and/or metal oxides of a transition metal of group VB, VIB, VIIB or VIIIB of the periodic table.

The polyamide moulding compound according to the invention is distinguished by having very good long-term heat-ageing resistance. The use of metal salts and/or metal oxides of a transition metal of group VB, VIB, VIIB or VIIIB of the periodic table can thereby be completely dispensed with. Optionally, a halogenide-free flame retardant can be added to the polyamide moulding compound, as a result of which excellent flame-retardant properties are achieved at the same time.

Surprisingly, it was established that the high heat stabilisation can be achieved by high contents of an organic stabiliser in combination with a caprolactam-containing component, halogenide salts being able to be dispensed with completely. Likewise, the polyamide moulding compound according to the invention achieves a wider temperature range of organic heat stabilisation.

According to the invention, a partially aromatic and, at the same time, partially crystalline polyamide with a melting point in the range of 255 to 330° C. is used as component (A1) of the polyamide mixture or polyamide matrix A. The melting point of polyamides thereby depends essentially only to a certain degree upon the molecular weight or the intrinsic viscosity of the polyamides, rather however is caused by the chemical composition due to the choice of corresponding monomers. Hence, the polyamides usable for the invention can vary over a wide range, with the precondition that the melting point thereof is in the previously mentioned range. The melting points for the respective partially aromatic and partial crystalline polyamides are tabulated standard parameters for the respective polyamides but can also be understood with simple tests.

There should be understood by a caprolactam-containing polyamide according to the invention, a polyamide which is producible by polymerisation of caprolactam or copolymerisation/-polycondensation of caprolactam with further monomers. The caprolactam-containing polymer hence comprises at least 50% by weight of repetition units which are derived from caprolactam.

In order to endow the filled or reinforced moulding compounds with adequate heat-ageing resistance, a caprolactam-containing polyamide is added to the partially crystalline, partially aromatic polyamide so that the caprolactam content of the polyamide matrix is 3 to 35, preferably 10 to 28 and particularly preferred 15 to 25% by weight. Using a higher concentration of caprolactam no longer substantially improves the heat-ageing resistance but reduces too greatly the thermostability of the moulding compounds and also the resistance at high temperatures. Below a caprolactam concentration of 3% by weight, relative to the sum of polyamides (A1) and (A2), the desired high heat-ageing resistance can no longer be guaranteed.

In the case of a preferred polyamide moulding compound according to the present invention, the polyamide mixture A consists of

(A.1) 70-78% by weight of at least one partially aromatic, partially crystalline polyamide with a melting point in the range of 255-330° C., and

(A.2) at least one caprolactam-containing polyamide with a content of caprolactam of at least 50% by weight,

component (A1) being free of caprolactam and aminocaproic acid, i.e. includes no repetition units derived herefrom.

The parameters or contents of further compounds mentioned further back are thereby maintained.

The polyamide moulding compounds according to the invention comprise 22 to 94.99% by weight, preferably 30 to 79.9% by weight, particularly preferred 35 to 60% by weight, of a polyamide matrix, consisting of partially crystalline, partially aromatic polyamides with a melting point of 255 to 330° C. (A1) and of polyamides differing from A1, based on caprolactam (A2).

The polyamide component (A2) consists of at least 50% by weight, preferably of at least 60% by weight and particularly preferred of at least 70% by weight of caprolactam. The polyamide component (A2) is preferably a partially crystalline, aliphatic polyamide.

The total caprolactam content, i.e. the sum of the caprolactam contained in polyamide (A1) and polyamide (A2), is thereby 10 to 30% by weight, preferably 12 to 29% by weight and particularly preferred 15 to 28% by weight, relative to the polyamide mixture of (A1) and (A2).

Preferably, the moulding compound according to the invention is free of polyolefins, in particular free of polyethylene-olefin copolymers.

Component (A1)

Component (A1) concerns partially crystalline, partially aromatic polyamides which preferably have a glass transition temperature in the range of 90 to 140° C., preferably in the range of 110 to 140° C. and in particular in the range of 115 to 135° C.

The melting point of polyamide (A1) is in the range of 255 to 330° C., preferably in the range of 270 to 325° C., and in particular in the range of 280 to 320° C.

Preferred partially aromatic, partially crystalline polyamides are thereby produced from

a) 30 to 100% by mol, in particular 50 to 100% by mol, of terephthalic acid and/or naphthalenedicarboxylic acid and also 0 to 70% by mol, in particular 0 to 50% by mol, of at least one aliphatic dicarboxylic acid with 6 to 12 carbon atoms, and/or 0 to 70% by mol, in particular 0 to 50% by mol, of at least one cycloaliphatic dicarboxylic acid with 8 to 20 carbon atoms, and/or 0 to 50% by mol of isophthalic acid, relative to the total quantity of dicarboxylic acids,

b) 80 to 100% by mol of at least one aliphatic diamine with 4 to 18 carbon atoms, preferably with 6 to 12 carbon atoms and also 0 to 20% by mol of at least one cycloaliphatic diamine, preferably with 6 to 20 carbon atoms, and/or 0 to 20% by mol of at least one araliphatic diamine, such as e.g. PACM, MACM, IPDA, MXDA and PXDA, relative to the total quantity of diamines, and also possibly

c) aminocarboxylic acids and/or lactams respectively with 6 to 12 carbon atoms.

According to a preferred embodiment, the partially aromatic polyamide of component (A1) is formed on the basis of at least 30% by mol, in particular at least 50% by mol, of terephthalic acid and at least 80% by mol of aliphatic diamines with 4 to 18 carbon atoms, preferably with 6-12 carbon atoms, and possibly further aliphatic, cycloaliphatic and aromatic dicarboxylic acids and also lactams and/or aminocarboxylic acids. As further aromatic dicarboxylic acids, isophthalic acid and naphthalenedicarboxylic acid can be used in addition to terephthalic acid. Suitable aliphatic and cycloaliphatic dicarboxylic acids which can be used in addition to terephthalic acid have 6 to 36 carbon atoms and are used in a proportion of at most 70% by mol, in particular in a proportion of at most 50% by mol, relative to the total quantity of dicarboxylic acids.

In addition, it is preferred that the mentioned aromatic dicarboxylic acids of the partially aromatic polyamide of component (A1) are selected from the group: terephthalic acid, isophthalic acid and also mixtures thereof.

According to a further preferred embodiment, the mentioned, for example aliphatic dicarboxylic acids of the partially aromatic polyamide of component (A1), which can be used in addition to terephthalic acid, are selected from the group adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid and dimer fatty acid (C36). Amongst the dicarboxylic acids, adipic acid, sebacic acid, dodecanedioic acid, isophthalic acid or a mixture of such dicarboxylic acids, in particular adipic acid and isophthalic acid and particularly adipic acid alone are preferred.

According to a further preferred embodiment, the mentioned aliphatic diamines of the partially aromatic polyamide of component (A1) are selected from the group 1,4-butanediamine, 1,5-pentanediamine, 1,6-hexanediamine, 1,7-heptanediamine, 1,8-octanediamine, 1,9-nonanediamine, methyl-1,8-octanediamine, 1,10-decanediamine, 1,11-undecanediamine, 1,12-dodecanediamine or a mixture of such diamines, 1,6-hexanediamine, 1,10-decanediamine, 1,12-dodecanediamine, or a mixture of such diamines being preferred, 1,6-hexanediamine and 1,10 decanediamine being particularly preferred. In addition to the aliphatic diamines, cycloaliphatic and/or araliphatic diamines can be replaced in a concentration of 0 to 20% by mol, relative to the total quantity of diamines.

For particular preference, the high-melting polyamides are formed from the following components:

a) (A1a) dicarboxylic acids:
50-100% by mol of aromatic terephthalic acid and/or napththalenedicarboxylic acid, relative to the total quantity of dicarboxylic acids present,
0-50% by mol of an aliphatic dicarboxylic acid, preferably with 6 to 12 carbon atoms, and/or a cycloaliphatic dicarboxylic acid with preferably 8 to 20 carbon atoms, and/or isophthalic acid;

b) (A1b) diamines:
80 to 100% by mol of at least one aliphatic diamine with 4-18 carbon atoms, preferably 6 to 12 carbon atoms, relative to the total quantity of diamines present,
0-20% by mol of cycloaliphatic diamines, preferably with 6 to 20 carbon atoms, and/or araliphatic diamines, such as e.g. PACM, MACM, IPDA, MXDA and PXDA,
the percentage molar content of dicarboxylic acids in the high-melting polyamides making 100% and the percentage molar content of diamines making 100%, and possibly from:

c) (A1c) aminocarboxylic acids and/or lactams, comprising lactams with preferably 6 to 12 carbon atoms, and/or aminocarboxylic acids with preferably 6 to 12 carbon atoms.

Whilst components (A1a) and (A1b) are used extensively equimolarly, the concentration of (A1c) is at most 20% by weight, preferably at most 15% by weight, in particular at most 12% by weight, respectively relative to the sum of (A1a) to (A1c).

In addition to the extensively equimolarly used components (A1a) and (A1b), dicarboxylic acids (A1a) or diamines (A1b) can be used for controlling the molar mass or compensating for monomer losses during polyamide production so that, in its totality, the concentration of component (A1a) or (A1b) can predominate.

Suitable cycloaliphatic dicarboxylic acids are cis- and/or trans-cyclohexane-1,4-dicarboxylic acid and/or cis- and/or trans-cyclohexane-1,3-dicarboxylic acid (CHDA).

The above-mentioned aliphatic diamines which are used compulsorily, can be replaced, in a subordinate quantity, of no more than 20% by mol, of preferably no more than 15% by mol and in particular no more than 10% by mol, relative to the total quantity of diamines, by different diamines. As cycloaliphatic diamines, for example cyclohexanediamine, 1,3-bis-(aminomethyl)-cyclohexane (BAC), isophoronediamine, norbornanedimethylamine, 4,4′-diaminodicyclohexylmethane (PACM), 2,2-(4,4′-diaminodicyclohexyl)propane (PACP) and 3,3′-dimethyl-4,4′-diaminodicyclohexylmethane (MACM). As araliphatic diamines, m-xylylenediamine (MXDA) and p-xylylenediamine (PXDA) may be mentioned.

In addition to the dicarboxylic acids and diamines described, also lactams and/or aminocarboxylic acids can be used as polyamide-forming components (component (A1c)) can be used. Suitable compounds are for example caprolactam (CL), α,ω-aminocaproic acid, α,ω-aminononanoic acid, α,ω-aminoundecanoic acid (AUA), laurinlactam (LL) and α,ω-aminododecanoic acid (ADA). The concentration of aminocarboxylic acids and/or lactams which are used together with components (A1a) and (A1b) is at most 20% by weight, preferably at most 15% by weight and particularly preferred at most 12% by weight, relative to the sum of components (A1a) to (A1c). Specially preferred are lactams or α,ω-amino acids with 4, 6, 7, 8, 11 or 12 C-atoms. These are the lactams pyrrolidin-2-one (4 C-atoms), 8-caprolactam (6 C-atoms), oenantholactam (7 C-atoms), capryllactam (8 C-atoms), laurinlactam (12 C-atoms) or α,ω-amino acids, 1,4-aminobutanoic acid, 1,6-aminohexanoic acid, 1,7-aminoheptanoic acid, 1,8-aminooctanoic acid, 1,11-aminoundecanoic acid and 1,12-aminododecanoic acid.

In a particularly preferred embodiment, component A1 is free of caprolactam or aminocaproic acid.

In order to control the molar mass, the relative viscosity or the flowability or the MVR, regulators in the form of monocarboxylic acids or monoamines can be added to the batch and/or to the precondensate (before the postcondensation). Aliphatic, cycloaliphatic or aromatic monocarboxylic acids or monoamines suitable as regulators are acetic acid, propionic acid, butyric acid, valeric acid, caproic acid, lauric acid, stearic acid, 2-ethylhexanoic acid, cyclohexanoic acid, benzoic acid, 3-(3-5-di-tert-butyl-4-hydroxyphenyl)propanoic acid, 3,5-di-tert-butyl-4-hydroxybenzoic acid, 3-(3-tert-butyl-4-hydroxy-5-methylphenyl)propanoic acid, 2-(3,5-di-tert-butyl-4-hydroxybenzylthio)acetic acid, 3,3-bis(3-tert-butyl-4-hydroxy-phenyl)butanoic acid, butylamine, pentylamine, hexylamine, 2-ethylhexylamine, n-octylamine, n-dodecylamine, n-tetradecylamine, n-hexadecylamine, stearylamine, cyclohexylamine, 3-(cyclohexylamino)-propylamine, methylcyclohexylamine, dimethylcyclohexylamine, benzylamine, 2-phenylethylamine, 2,2,6,6-tetramethylpiperidine-4-amine, 1,2,2,6,6-pentamethylpiperidine-4-amine, 4-amino-2,6-di-tert-butylphenol inter alia. The regulators can be used individually or in combination. Also other monofunctional compounds can be used as regulators which can react with an amino or acid group, such as anhydrides, isocyanates, acid halogenides or esters. The normal quantity of use of regulators is between 10 and 200 mmol per kg of polymer.

The partially aromatic copolyamides (A1) can be produced with methods which are known per se. Suitable methods have been described in various passages and consequently some of the possible methods discussed in the patent literature are indicated, the disclosure content of the subsequently mentioned documents is included, with respect to the method for the production of the copolyamide of component (A) of the present invention, expressly in the disclosure content of the present application: DE-A-195 13 940, EP-A-0 976 774, EP-A-0 129 195, EP-A-0 129 196, EP-A-0 299 444, U.S. Pat. No. 4,831,106, U.S. Pat. No. 4,607,073, DE-A-14 95 393 and U.S. Pat. No. 3,454,536.

Concrete representatives of the polyamides (A1) according to the invention are: PA 4T/4I, PA 4T/6I, PA 5T/5I, PA 6T/6, PA 6T/6I, PA 6T/6I/6, PA 6T/66, 6T/610, 6T/612, PA 6T/10T, PA 6T/10I, PA 9T, PA 10T, PA 12T, PA 10T/10I, PA 10T/106, PA 10T/12, PA 10T/11, PA 6T/9T, PA 6T/12T, PA 6T/10T/6I, PA 6T/6I/6, PA 6T/6I/12 and also mixtures thereof, particularly preferably the partially aromatic polyamide of component (A) is selected from the group: PA 6T/6I, PA 6T/66, PA 6T/10T, PA 6T/10T/6I and also mixtures thereof. Polyamides (A1) which comprise 6T units, in particular at least 10% by weight of 6T units, are preferred.

According to the invention, in particular the following partially aromatic copolyamides are therefore preferred as high-melting polyamides (A1):
partially crystalline polyamide 6T/6I with 50 to 80% by mol of hexamethyleneterephthalamide units and 20 to 50% by mol of hexamethyleneisophthalamide units;
partially crystalline polyamide 6T/6I with 55 to 75% by mol of hexamethyleneterephthalamide units and 25 to 45% by mol of hexamethyleneisophthalamide units;
partially crystalline polyamide 6T/6I with 62 to 73% by mol of hexamethyleneterephthalamide units and 25 to 38% by mol of hexamethyleneisophthalamide units;
partially crystalline polyamide 6T/6I with 70% by mol of hexamethyleneterephthalamide units and 30% by mol of hexamethyleneisophthalamide units;
partially crystalline polyamide 6T/66 with 30 to 80% by mol of hexamethyleneterephthalamide units and 20 to 70% by mol of hexamethyleneadipamide units;
partially crystalline polyamide 6T/66 with 50 to 70% by mol of hexamethyleneterephthalamide units and 30 to 50% by mol of hexamethyleneadipamide units;
partially crystalline polyamide 6T/66 with 50 to 60% by mol of hexamethyleneterephthalamide units and 40 to 50% by mol of hexamethyleneadipamide units;
partially crystalline polyamide 6T/66 with 55 to 60% by mol of hexamethyleneterephthalamide units and 40 to 45% by mol of hexamethyleneadipamide units;
partially crystalline polyamide, produced from at least 50% by mol of terephthalic acid and at most 50% by mol of isophthalic acid and also a mixture of at least two diamines, selected from the group hexamethylenediamine, nonanediamine, methyloctanediamine and decanediamine;
partially crystalline polyamide, produced from at least 70% by mol of terephthalic acid and at most 30% by mol of isophthalic acid and also from a mixture of hexamethylenediamine and dodecanediamine;
partially crystalline polyamide, produced from at least 50% by mol of terephthalic acid and at most 50% by mol of dodecanedioic acid and also from a mixture of at least two diamines, selected from the group hexamethylenediamine, nonanediamine, methyloctanediamine and decanediamine;
partially crystalline polyamide 6T/10T with 10 to 60% by mol, preferably 10 to 40% by mol, of hexamethyleneterephthalamide-(6T)- and 40 to 90% by mol, preferably 60 to 90% by mol, of decamethyleneterephthalamide-(10T) units;
partially crystalline polyamide 6T/10T/6I with 50 to 90% by mol, preferably 50-70% by mol, of hexamethyleneterephthalamide-(6T)- and 5 to 45% by mol, preferably 10-30% by mol, of hexamethyleneisophthalamide-(6I) units and 5 to 45% by mol, preferably 20-40% by mol, of decamethyleneterephthalamide-(10T) units;
partially crystalline polyamide 6T/6I/6 with 60 to 85% by mol of hexamethyleneterephthalamide-(6T)- and 15 to 40% by mol of hexamethyleneisophthalamide-(6I) units which comprises in addition 5-15% by weight of caprolactam.

The partially aromatic, partially crystalline polyamide (A1) has a solution viscosity ηᵣₑₗ, measured according to DIN EN ISO 307 on solutions of 0.5 g polymer in 100 ml m-cresol at a temperature of 20° C., of at most 2.6, preferably of at most 2.3, in particular of at most 2.0. Preferably, polyamides (A1) with a solution viscosity ηᵣₑₗ are in the range of 1.45 to 2.3, in particular in the range of 1.5 to 2.0 or 1.5 to 1.8.

The polyamides (A1) according to the invention can be produced in normal polycondensation plants via the process sequence of precondensate and postcondensation. For the polycondensation, preferably the chain regulators described are used for controlling the viscosity. In addition, the viscosity can be adjusted by use of a diamine- or diacid excess.

Component (A2)

Component (A2) concerns caprolactam-containing polyamides with a content of caprolactam of at least 50% by weight, preferably of at least 60% by weight and particularly preferred of at least 70% by weight. In particular, (A2) concerns polyamide PA 6.

In the case where component (A2) concerns a copolymer, preferred comonomers for (A2), which are used in addition to caprolactam, are, on the one hand, combinations of diamines and dicarboxylic acids which are used preferably equimolarly or almost equimolarly, and, on the other hand, lactams and aminocarboxylic acids.

Suitable diamines are in particular branched or linear aliphatic diamines with 4 to 18 C-atoms. Suitable dicarboxylic acids are aliphatic, cycloaliphatic or aromatic dicarboxylic acids with 6 to 36 carbon atoms.

According to a first preferred embodiment, the C4-C, 18 diamine concerns a diamine selected from the group 1,4-butanediamine, 1,5-pentanediamine, 2-methylpentanediamine, 1,6-hexanediamine, 1,7-heptanediamine, 1,8-octanediamine, 1,9-nonanediamine, methyl-1,8-octanediamine, 2,2,4-trimethylhexanediamine, 2,4,4-trimethylhexanediamine, 1,10-decanediamine, 1,11-undecanediamine, 1,12-dodecanediamine, 1,13-tridecanediamine, 1,14-tetradecanediamine, 1,15-pentadecanediamine, 1,16-hexadecanediamine, 1,17-heptadecanediamine, 1,18-octadecanediamine, 4,4′-diaminodicyclohexylmethane (PACM), 2,2-(4,4′-diaminodicyclohexyl)propane (PACP), 3,3′-dimethyl-4,4′-diaminodicyclohexylmethane (MACM), m-xylylenediamine, p-xylylenediamine or a mixture of such diamines, 1,6-hexanediamine, 1,10-decanediamine, 1,12-dodecanediamine, or a mixture of such diamines, 1,6-hexanediamine and 1,10-decanediamine being preferred, and 1,6-hexanediamine alone being particularly preferred.

Suitable aliphatic dicarboxylic acids are adipic acid, butyric acid, azelaic acid, sebacic acid, undecanedioic acid, dodecanedioic acid, brassylic acid, tetradecanedioic acid, pentadecanedioic acid, hexadecanedioic acid, octadecanedioic acid and dimer fatty acid (C36). Suitable cycloaliphatic dicarboxylic acids are cis- and/or trans-cyclohexane-1,4-dicarboxylic acid and/or cis- and/or trans-cyclohexane-1,3-dicarboxylic acid (CHDA). Suitable aromatic dicarboxylic acids are terephthalic acid, isophthalic acid and naphthalenedicarboxylic acid. Amongst the dicarboxylic acids, adipic acid, sebacic acid, dodecanedioic acid, isophthalic acid, terephthalic acid or a mixture of such dicarboxylic acids, preferably adipic acid and terephthalic acid and particularly adipic acid alone, are preferred.

Further preferred comonomers for polyamide (A2) are possibly lactams or aminocarboxylic acids with 7 to 12 carbon atoms, laurinlactam and aminolauric acid being particularly preferred.

Particularly preferred polyamides of type (A2) are copolyamides, produced from the monomers caprolactam and laurinlactam or caprolactam, hexanediamine and adipic acid or caprolactam, hexanediamine and terephthalic acid, i.e. copolyamides PA 6/12 or PA 6/66 or PA 6/6T or PA 6/12/66 or PA 6/66/610, the caprolactam content of which is at least 50% by weight.

The caprolactam-containing polyamide (A2) has a solution viscosity ηᵣₑₗ, measured according to DIN EN ISO 307 on solutions of 0.5 g polymer dissolved in 100 ml m-cresol at a temperature of 20° C., in the range of 1.6 to 3.0, preferably in the range of 1.7 to 2.5, in particular in the range of 1.8 to 2.2.

Preferably, the at least one heat stabiliser is selected from the group consisting of N,N′-hexamethylene-bis-3-(3,5-di-tert-butyl-4-hydroxyphenyl)-propionamide, bis-(3,3-bis-(4′-hydroxy-3′-tert-butylphenyl)-butanoic acid)-glycol ester, 2,1′-thioethylbis-(3-(3,5-di-tert-butyl-4-hydroxyphenyl)-propionate, 4,4′-butylidene-bis-(3-methyl-6-tert-butylphenol), triethyleneglycol-3-(3-tert-butyl-4-hydroxy-5-methylphenyl)-propionate, octadecyl-3-(3,5-di-tert-butyl-4-hydroxyphenyl)propionate, 1,3,5-trimethyl-2,4,6-tris(3,5-di-tert-butyl-4-hydroxybenzyl)benzene, Brüggolen TP-H7005 or mixtures of two or more thereof. For particular preference, of the previously mentioned heat stabilisers, stabilisers based on sterically hindered phenols, in particular Brüggolen TP-H7005, are used.

The at least one heat stabiliser based on sterically hindered phenols is thereby contained preferably in a quantity of 0.1 to 1.5% by weight, particularly preferred of 0.2 to 1% by weight.

It is particularly preferred that the polyamide moulding compound is free of inorganic stabilisers based on transition metals and metals of the main group III to V, particularly preferred completely free of inorganic stabilisers.

PA moulding compounds which comprise organic stabilisers have, relative to PA moulding compounds provided with inorganic stabilisers, such as e.g. stabilisers based on copper, improved contact corrosion behaviour.

In a preferred embodiment of the polyamide moulding compound according to the invention, at least one further heat stabiliser is an organic stabiliser selected from the group consisting of
stabilisers based on secondary aromatic amines, in particular adducts from phenylenediamine with acetone (Naugard A) adducts from phenylenediamine with linolene, Naugard 445, N,N′-dinaphthyl-p-phenylenediamine, N-phenyl-N′-cyclohexyl-p-phenylenediamine or mixtures of two or more thereof,
stabilisers from the group of phosphites and phosphonites, in particular triphenylphosphite, diphenylalkylphosphite, phenyldialkylphosphite, tris(nonylphenyl)phosphite, trilaurylphosphite, trioctadecylphosphite, distearylpentaerythritoldiphosphite, tris(2,4-di-tert-butylphenyl)phosphite, diisodecylpentaerythritoldiphosphite, bis(2,4-di-tert-butylphenyl)pentaerythritoldiphosphite, bis(2,6-di-tert-butyl-4-methylphenyl)-pentaerythritoldiphospite, diisodecyloxypentaerythritoldiphospite, bis(2,4-di-tert-butyl-6-methylphenyl)pentaerythritoldiphosphite, bis(2,4,6-tris-(tert-butylphenyl))pentaerythritoldiphosphite, tristearylsorbitoltriphosphite, tetrakis(2,4-di-tert-butylphenyl)-4,4′-biphenylenediphosphonite, 6-isooctyloxy-2,4,8,10-tetra-tert-butyl-12H-dibenz-[d,g]-1,3,2-dioxaphosphocine, 6-fluoro-2,4,8,10-tetra-tert-butyl-12-methyl-dibenz[d,g]-1,3,2-dioxaphosphocine, bis(2,4-di-tert-butyl-6-methylphenyl)methylphosphite and bis(2,4-di-tert-butyl-6-methylphenyl)ethylphosphite, tris[2-tert-butyl-4-thio(2′-methyl-4′-hydroxy-5′-tert-butyl)-phenyl-5-methyl]phenyl-phosphite and tris(2,4-di-tert-butylphenyl)phosphite (Hostanox® PAR24: commercial product of the company Clariant, Basel) Brüggolen TP-H7005, 2,6-di-tert-butyl-4-(4,6-bis(octylthio)-1,3,5-triazian-2-ylamino)phenol (Irganox® 565: commercial product of the company BASF), triethyleneglycol bis(3-tert-butyl-4-hydroxy-5-methylphenyl)propionate (Irganox® 245: commercial product of the company BASF), tetrakis-methylene(3,5-di-tert-butyl-4-hydroxyhydrocinnamate)methane (Irganox® 1010: commercial product of the company BASF), 3-(3,5-di-tert-butyl-4-hydroxyphenyl)propionic acid (Irganox® 1310: commercial product of the company BASF), 2,2″-methylenebis-(6-tert-butyl-p-cresol)monoacrylate (Irganox® 3052: commercial product of the company BASF)
mixtures hereof.

Furthermore, it is preferred that the polyamide moulding compound comprises 0.2 to 2% by weight, preferably 0.2 to 1.5% by weight, of stabilisers based on secondary amines and/or 0.1 to 1.5% by weight, preferably 0.2 to 1% by weight, of stabilisers based on sterically hindered phenols and/or 0.1 to 1.5% by weight, preferably 0.2 to 1% by weight, of stabilisers from the group of phospites and phosphonites, the total proportion of organic stabilisers in the polyamide moulding compound being no more than 3% by weight.

The contact corrosion behaviour plays an important role if moulded articles made of the moulding compounds according to the invention are brought in contact with metals. If the moulded articles have purely organic stabilisers, the corrosion of the metals in contact can be almost completely, in particular completely suppressed. Contact corrosion behaviour can be quantified via the electrical conductivity of the PA moulding compound, it is 1*10⁻⁶ to 0.5*10⁻¹¹ S, preferably 1*10⁻⁸ to 8*10⁻¹⁰ S and particularly preferred 3*10⁻⁹ to 3*10⁻¹° S, determined as described in the experimental part.

In general, halogen-free flame retardants are possible for the present invention. As a result, it is made possible that the polyamide moulding compounds according to the invention have excellent flame-retardant properties, in addition to very good long-term heat-ageing resistance.

A preferred embodiment of the polyamide moulding compound according to the invention provides that the at least one flame retardant is halogen-free. The halogen-free flame retardant is thereby preferably selected from the group consisting of melamine cyanurate, melamine phosphate, melamine pyrophosphate, melamine polyphosphate, melem phosphate, melem pyrophosphate, dimelamine pyrophosphate, dimelamine phosphate, melon polyphosphate, phosphaphenanthrenes, metal hydroxides, phosphinic acid salts, diphosphinic acid salts and combinations hereof.

Furthermore, it is preferred that the flame retardant comprises in addition at least one synergist, the at least one synergist being preferably selected from the group consisting of nitrogen-containing compounds, nitrogen- and phosphorus-containing compounds, metal borates, metal carbonates, metal hydroxides, metal hydroxyoxides, metal nitrides, metal oxides, metal phosphates, metal sulphides, metal stannates, metal hydroxystannates, silicates, zeolites, basic zinc silicates, silicic acids and combinations hereof, in particular triazine derivatives, melamine, guanidine, guanidine derivatives, biuret, triuret, tartrazine, glycoluril, acetoguanamine, butyroguanamine, caprinoguanamine, benzoguanamine, melamine derivatives of cyanuric acid, melamine derivates of isocyanuric acid, melamine cyanurate, condensation products of melamine, melamine pyrophosphate, pyrophospates of the condensation products of melamine, dimelamine phosphate, dimelamine pyrophosphate, melamine polyphosphate, dicyandiamide, ammonium polyphosphate, ammonium hydrogen phosphate, ammonium dihydrogen phosphate, polyphosphates of the condensation products of melamine, melamine sulphate, allantoin, aluminium hydroxide, synthetic aluminium metahydroxide (synthetic aluminium hydroxyoxide), natural aluminium metahydroxide (natural aluminium hydroxyoxide), aluminium oxide, calcium borate, calcium carbonate, calcium magnesium carbonate, calcium oxide, calcium sulphide, iron oxide, magnesium borate, magnesium carbonate, magnesium hydroxide, magnesium nitride, magnesium oxide, magnesium sulphide, manganese hydroxide, manganese oxide, titanium nitride, titanium dioxide, zinc borate, zinc metaborate, zinc carbonate, zinc hydroxide, zinc nitride, zinc oxide, zinc phosphate, zinc sulphide, zinc stannate, zinc hydroxystannate, basic zinc silicate, tin oxide hydrate and combinations hereof

It is however likewise possible that the flame retardant is free of synergists.

Furthermore, it is preferred that the at least one flame retardant is a phosphinic acid salt of the general formula (I)

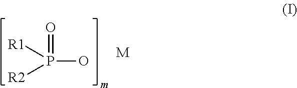

and/or formula (II)

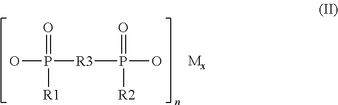

and/or one of the polymers thereof, R1 and R2 being the same or different and being selected from the group consisting of linear or branched C1-C8 alkyl and/or aryl, R3 being selected from the group consisting of linear or branched C1-C10 alkylene, C6-C10 arylene, alkylarylene and arylalkylene, M being a metal ion from the 2^{nd} or 3^{rd} main or subsidiary group of the periodic table, preferably Al, Ba, Ca or Zn, m being 2 or 3, n 1 or 3, and x 1 or 2.

The flame retardant, Exolit OP 1230, commercialised by the company Clariant, which concerns the aluminium salt of diethylphosphinic acid (CAS-No. 225789-38-8), is particularly preferred.

Metal-free flame retardants are particularly preferred.

The polyamide moulding compound preferably comprises 5 to 24% by weight, preferably 6 to 23% by weight, particularly preferred 7 to 21% by weight, of the at least one flame retardant. If more than 25% by weight of component b) is added, the mechanical properties suffer too greatly, below 5% by weight, in contrast, the flame-retardant properties are affected negatively.

In a preferred embodiment, the moulding compound is classified according to IEC 60695-11-10 of (UL94) as V-0.

In a further preferred embodiment of the polyamide moulding compound according to the invention, the at least one additive is selected from the group consisting of light stabilisers, UV stabilisers, UV absorbers or UV blockers, lubricants, colourants, nucleation agents, antistatic agents, conductivity additives, mould-release agents, fillers, reinforcing agents, optical brighteners or mixtures hereof

The fillers are selected in particular from the group consisting of whiskers, talcum, mica, silicates, quartz, titanium dioxide, wollastonite, kaolin, silicic acid, magnesium carbonate, magnesium hydroxide, chalk, ground or precipitated calcium carbonate, lime, field spar, barium sulphate, glass balls, hollow glass balls, hollow-ball silicate fillers, natural layer silicates, synthetic layer silicates and mixtures hereof.

Reinforcing agents are preferably fibres, in particular glass fibres and/or carbon fibres. Furthermore, it is preferred that the fibres concern fibres with a circular cross-sectional area, fibres with a non-circular cross-sectional area or a mixture of fibres with a circular cross-sectional area and fibres with a non-circular cross-sectional area, the proportion of fibres with a non-circular cross-sectional area in the mixture preferably being at least 50% by weight and, in the case of the fibres with the non-circular cross-sectional area, the dimensional ratio of the main cross-sectional axis to the subsidiary cross-sectional axis being preferably >2, particularly preferred in the range of 2 to 8, very particularly preferred in the range of 3 to 5. Preferably, the fibres are short fibres, preferably with a length in the range of 2 to 50 mm and a diameter of 5 to 40 μm, and/or endless fibres (rovings).

If flat glass fibres with a non-circular cross-sectional area are used, these are preferably used as short glass fibre (cut glass with a length of 0.2 to 20 mm, preferably of 2 to 12 mm).

A further preferred embodiment provides that the reinforcing agents are glass fibres with a non-circular cross-sectional area and a dimensional ratio of the main cross-sectional axis to the subsidiary cross-sectional axis of more than 2, preferably of 2 to 8, particularly preferred of 3 to 5, the glass fibres having an oval, elliptical, rectangular, or almost rectangular cross-sectional area provided with constrictions or one constriction and the glass fibres being preferably 0.2 to 20 mm, particularly preferred 2 to 12 mm, in length, the length of the main cross-sectional axis being preferably in the range of 6 to 40 μm, particularly preferred in the range of 15 to 30 μm, and the length of the subsidiary cross-sectional axis being preferably in the range of 3 to 20 μm, particularly preferred in the range of 4 to 10 μm.

In a further preferred embodiment of the polyamide moulding compound according to the invention, this is free of metallic pigments.

For use in applications in which the contact corrosion behaviour is of relevance, a moulding compound as follows is preferred:

a) 22 to 99.99% by weight of a polyamide mixture is provided, consisting of
(A1) at least one partially aromatic, partially crystalline polyamide with a melting point in the range of 255 to 330° C.,
(A2) at least one caprolactam-containing polyamide which differs from the at least one partially aromatic, partially crystalline polyamide (A1) and has a content of caprolactam of at least 50% by weight,
   the total caprolactam content of the caprolactam contained in polyamide (A1) and polyamide (A2), relative to the polyamide mixture, being 3 to 35% by weight,

b) 0.01 to 3.0% of at least one organic heat stabiliser, in particular stabilisers based on sterically hindered phenols, and

c) 0 to 50% by weight of at least one additive,

components a) to c) adding up to 100% by weight. The polyamide moulding compound is thereby free of metal salts and/or metal oxides.

For particular preference for applications in which the contact corrosion behaviour is of relevance, a moulding compound as follows is provided:

a) 27 to 84.99% by weight of a polyamide mixture, consisting of
(A1) at least one partially aromatic, partially crystalline polyamide with a melting point in the range of 255 to 330° C.,
(A2) at least one caprolactam-containing polyamide which differs from the at least one partially aromatic, partially crystalline polyamide (A1) and has a content of caprolactam of at least 50% by weight,
   the total caprolactam content of the caprolactam contained in polyamide (A1) and polyamide (A2), relative to the polyamide mixture, being 3 to 35% by weight,

b) 15 to 65% by weight of fillers or reinforcing agents,

c) 0.1 to 3.0% by weight of at least one organic heat stabiliser, in particular stabilisers based on sterically hindered phenols, and

d) 0 to 5.0% of at least one additive, components a) to c) adding up to 100% by weight. The polyamide moulding compound is thereby free of metal salts and/or metal oxides.

Furthermore, the present invention relates to a method for the production of such polyamide moulding compounds. It relates in addition to moulded articles which are produced using such polyamide moulding compounds.

Applications

In addition, the invention relates to uses of moulded parts which consist at least partially of such polyamide moulding compounds. Moulded parts which are brought at least partially in contact with metals are preferred.

For the automotive field, there may be mentioned by way of example: cylinder head covers, engine covers, housings for charge coolers, charge cooler flaps, intake pipes, in particular intake manifolds, connectors, gearwheels, fan impellers, cooling water boxes, housings or housing parts for heat exchangers, coolant coolers, charge coolers, thermostat, water pump, heating body, attachment parts. In the field of electrics/electronics, such uses are for example parts of jump start assistance points, circuit boards, housings, foils, pipes, switches, distributors, relays, resistors, capacitors, coils, lamps, diodes, LEDs, transistors, connectors, regulators, stores and sensors.

The present invention is explained in more detail with reference to the following examples without restricting the invention to the specific embodiments represented here.

### EXAMPLES

In Table 1, the materials used for the examples are compiled.

TABLE 1

| | | | rel. | H₂O content |
|---|---|---|---|---|
| Material | Trade name | Supplier | viscosity | [% by wt.) |
| PA 6T/66 | — | EMS-CHEMIE AG (CH) | 1.58^{a} | ≦0.08 |
| (55:45% by mol) | | | | |
| PA 6 | Grilon A28 | EMS-CHEMIE AG (CH) | 2.75^{b} | ≦0.08 |
| KI/Ca stearate | — | AJAY Europe (FR)^{c} | — | — |
| (ratio 98:2) | | | | |
| copper iodide | — | William Blythe (UK) | — | — |
| kaolin | — | ECC (GB) | — | — |
| stabiliser mixture | Recycloblend ® 660 | PolyAd Services (DE) | — | — |
| stabiliser 1 | Irganox 1076 | BASF (CH) | — | — |
| stabiliser 2 | Irganox 1098 | BASF (CH) | — | — |
| stabiliser 3 | Irganox 1330 | BASF (CH) | — | — |
| flame retardant | Exolit OP1230 | Clariant (DE) | — | — |
| glass fibre | Vetrotrex 995 EC10-4.5 | OCV (FR) | — | — |

^{a}determined according to ISO 307 (0.5 g polyamide in 100 ml m-cresol), calculation of the relative viscosity (RV) according to RV = t/t₀ following section 11 of the standard;
^{b}determined according to ISO 307 (0.5 g polyamide in 100 ml formic acid), calculation of the relative viscosity (RV) according to RV = t/t₀ following section 11 of the standard;
^{c}supplier of KI, mixing with Ca stearate effected at EMS.

Production of the Moulding Compounds and Compounds

The moulding compounds for examples E1 to E4 according to the invention and also for the comparative examples CE1 to CE3 were produced on a twin-shaft extruder of the company Werner and Pfleiderer type ZSK25. The quantity proportions, indicated in Table 2, of the starting materials in per cent by weight (% by weight), relative to 100% by weight of the total moulding compound compounded in the twin-shaft extruder.

TABLE 2

| | E1 | E2 | E3 | E4 | CE1 | CE2 | CE3 |
|---|---|---|---|---|---|---|---|
| Composition | | | | | | | |
| PA 6T/66 | 42.485 | 51.835 | 50.835 | 51.835 | 57.485 | 46.9 | 52.0 |
| PA 6 | 15.0 | 16.9 | 16.9 | 16.9 | — | 10.5 | 16.9 |
| Kl/Ca stearate | — | — | — | — | — | 0.3 | 0.3 |
| copper iodide | — | — | — | — | — | 0.035 | 0.035 |
| kaolin | 0.265 | 0.265 | 0.265 | 0.265 | 0.265 | 0.265 | 0.265 |
| stabiliser mixture | — | — | — | — | — | — | 0.5 |
| stabiliser 1 | — | 1.0 | 2.0 | — | — | — | — |
| stabiliser 2 | 0.25 | — | — | — | 0.25 | — | — |
| stabiliser 3 | — | — | — | 1.0 | — | — | — |
| flame retardant | 12.0 | — | — | — | 12.0 | 12.0 | — |
| glass fibre | 30.0 | 30.0 | 30.0 | 30.0 | 30.0 | 30.0 | 30.0 |
| Properties | | | | | | | |
| flame retardance | V-0 | n.d | n.d | n.d | V-0 | V-0 | n.d |
| contact corrosion | (+) | (+) | (+) | (+) | (+) | (−) | (−) |
| behaviour | | | | | | | |
| conductivity tested | 4.4 * 10⁻¹¹ | 1.3 * 10⁻¹¹ | 1.0 * 10⁻¹¹ | 1.1 * 10⁻¹¹ | 5.3 * 10⁻¹¹ | 5.2 * 10−⁹ | 1.2 * 10⁻¹⁰ |
| [S] | | | | | | | |
| CTI tested [V] | 600 | 600 | 600 | 600 | 600 | 575 | 575 |
| heat-ageing | (+) | (+) | (+) | (+) | (−) | (+) | (+) |
| resistance | | | | | | | |

n.d = not determined
(+) = no visible corrosion;
(−) = visible corrosion

The polyamide granulates were metered together with the additives into the feed zone, whilst the glass fibre was metered into the polymer melt via side feeder 3 housing units in front of the nozzle. The housing temperature was adjusted as an increasing profile to 320° C. At 150 to 250 rpm, 15 kg throughput was achieved. After cooing of the strands in the water bath, granulation and drying at 120° C. for 24 hours, injection moulding of the compounds was effected to form ISO test pieces. Injection moulding took place on an injection moulding machine Arburg Allrounder 320-210-750 at cylinder temperatures of 300° C. to 325° C. of zones 1 to 4 and a mould temperature of 135° C.

In Table 3, the mechanical properties after heat storage at 220° C. are compiled.

TABLE 3

| | CE1 | E1 |
|---|---|---|
| Mechanical properties (after 0 h) | | |
| Breaking strength [MPa] | 139.7 | 161.1 |
| Breaking elongation [%] | 1.6 | 2.4 |
| Mechanical properties (after 1000 h) | | |
| Breaking strength [MPa] | 30.9 | 150.5 |
| Breaking elongation [%] | 0.5 | 1.9 |
| Mechanical properties (after 1500 h) | | |
| Breaking strength [MPa] | 11.3 | 148.3 |
| Breaking elongation [%] | 0.1 | 1.9 |
| Mechanical properties (after 2000 h) | | |
| Breaking strength [MPa] | 7.8 | 131.2 |
| Breaking strength relative to the initial value [%] | 5.6 | 81.4 |
| Breaking elongation [%] | 0.1 | 1.5 |
| Breaking elongation relative to the initial value [%] | 6.3 | 62.5 |

Determination of the properties indicated in Tables 2 and 3 was effected according to the following methods.

Implementation of the Heat Storage

The heat storage was implemented in ventilated, electrically heated individual chamber heat cabinets according to IEC 60216-4-1 at 220° C. on ISO tensile test bars (standard: ISO 3167, Type A, 170×20/10×4 mm). After the times indicated in Table 3, test pieces were removed from the furnace and tested, after cooling to 23° C., according to the methods indicated below.

Determination of the Breaking Strength and Breaking Elongation

Determination of the breaking strength and breaking elongation was effected according to ISO 527 with a tensile speed of 5 mm/min on an ISO tensile test piece according to the standard ISO 3167, Type A with the dimensions 170×20/10×4 mm at a temperature of 23° C.

Determination of the Flame-Retardant Properties

The flame-retardant properties were determined in the vertical fire test according to IEC 60695-11-10 (UL94) on test pieces with a wall thickness of 0.8 mm. The test pieces were stored before testing for 7 days at 70° C.

Assessment of the Heat-Ageing Resistance

The heat-ageing resistance was assessed with (+) if the mechanical properties determined as described above after 2,000 hours were still greater than 50% of the initial values, i.e. before the heat storage.

Assessment of the Contact Corrosion Behaviour

Description of the Visual Assessment Included

Sheets of the materials (80*80*3 mm, film moulding) were stored initially for 500 hours at 85° C. and 85% air humidity. A copper sheet (10*80*1 mm) was pressed subsequently on the pre-positioned sheets. The sheets contacted with the copper sheet were stored for a further 1,000 hours in room conditions and subsequently the copper sheet was removed and the corrosion assessed visually.

Determination of the Conductivity

Sheets of the materials (80*80*3 mm, film moulding) were stored initially for 500 hours at 85° C. and 85% air humidity. Subsequently, the sheets were provided, in the diagonal, with two strips of conductive silver (200N Hans Wolbring GmbH) at a spacing of one centimetre. The surface was contacted on the conductive silver strips and the surface resistance was tested and measured. The indicated conductivity corresponds to the reciprocal surface resistance.

Determination of the Tracking Resistance (CTI)

Determination of the CTI was effected according to IEC60112.

1. A polyamide moulding compound consisting of
a) 22 to 99.99% by weight of a polyamide mixture, consisting of
(A1) at least one partially aromatic, partially crystalline polyamide with a melting point in the range of 255 to 330° C. and
(A2) at least one caprolactam-containing polyamide which differs from the at least one partially aromatic, partially crystalline polyamide (A1) and has a content of caprolactam of at least 50% by weight,
the total caprolactam content of the caprolactam contained in polyamide (A1) and polyamide (A2), relative to the polyamide mixture, being 3 to 35% by weight,
b) 0 to 25% by weight of at least one flame retardant,
c) 0.01 to 3.0% by weight of at least one organic heat stabiliser based on sterically hindered phenols and
d) 0 to 50% by weight of at least one additive,
components a) to d) adding up to 100% by weight,
wherein the polyamide moulding compound is free of metal salts and/or metal oxides of a transition metal of group VB, VIB, VIIB or VIIIB of the periodic table.

2. The polyamide moulding compound according to claim 1, wherein the electrical conductivity of the moulding compound is 1*10⁻⁶ to 0.5*10⁻¹¹ S.

3. The polyamide moulding compound according to claim 1, wherein the polyamide moulding compound is free of inorganic stabilisers based on transition metals and metals of the main group III to V.

4. The polyamide moulding compound according to claim 1, wherein the at least one heat stabiliser based on sterically hindered phenols is selected from the group consisting of N,N′-hexamethylene-bis-3-(3,5-di-tert-butyl-4-hydroxyphenyl)-propionamide, bis-(3,3-bis-(4′-hydroxy-3′-tert-butylphenyl)-butanoic acid)-glycol ester, 2,1′-thioethylbis-(3-(3,5-di-tert-butyl-4-hydroxyphenyl)-propionate, 4,4′-butylidene-bis-(3-methyl-6-tert-butylphenol), triethyleneglycol-3-(3-tert-butyl-4-hydroxy-5-methylphenyl)-propionate, octadecyl-3-(3,5-di-tert-butyl-4-hydroxyphenyl)propionate, 1,3,5-trimethyl-2,4,6-tris(3,5-di-tert-butyl-4-hydroxybenzyl)benzene and mixtures of two or more thereof.

5. The polyamide moulding compound according to claim 1, wherein the at least one heat stabiliser based on sterically hindered phenols is contained in a quantity of 0.1 to 1.5% by weight.

6. The polyamide moulding compound according to claim 1, wherein at least one further heat stabiliser is selected from the group of
stabilisers based on secondary aromatic amines,
stabilisers from the group of phosphites and phosphonites
and
mixtures thereof.

7. The polyamide moulding compound according to claim 1, wherein the at least one flame retardant is halogen-free, the halogen-free flame retardant being selected from the group consisting of melamine cyanurate, melamine phosphate, melamine pyrophosphate, melamine polyphosphate, melem phosphate, melem pyrophosphate, dimelamine pyrophosphate, dimelamine phosphate, melem polyphosphate, phosphaphenanthrenes, metal hydroxides, phosphinic acid salts, diphosphinic acid salts and combinations hereof.

8. The polyamide moulding compound according to claim 1, wherein the flame retardant comprises in addition at least one synergist, the at least one synergist being selected from the group consisting of nitrogen-containing compounds, nitrogen- and phosphorus-containing compounds, metal borates, metal carbonates, metal hydroxides, metal hydroxyoxides, metal nitrides, metal oxides, metal phosphates, metal sulphides, metal stannates, metal hydroxystannates, silicates, zeolites, basic zinc silicates, silicic acids and combinations hereof, in particular triazine derivatives, melamine, guanidine, guanidine derivatives, biuret, triuret, tartrazine, glycoluril, acetoguanamine, butyroguanamine, caprinoguanamine, benzoguanamine, melamine derivatives of cyanuric acid, melamine derivates of isocyanuric acid, melamine cyanurate, condensation products of melamine, melamine pyrophosphate, pyrophospates of the condensation products of melamine, dimelamine phosphate, dimelamine pyrophosphate, melamine polyphosphate, dicyandiamide, ammonium polyphosphate, ammonium hydrogen phosphate, ammonium dihydrogen phosphate, polyphosphates of the condensation products of melamine, melamine sulphate, allantoin, aluminium hydroxide, synthetic aluminium hydroxyoxide, synthetic aluminium metahydroxide, natural aluminium hydroxyoxide, natural aluminium metahydroxide, aluminium oxide, calcium borate, calcium carbonate, calcium magnesium carbonate, calcium oxide, calcium sulphide, iron oxide, magnesium borate, magnesium carbonate, magnesium hydroxide, magnesium nitride, magnesium oxide, magnesium sulphide, manganese hydroxide, manganese oxide, titanium nitride, titanium dioxide, zinc borate, zinc metaborate, zinc carbonate, zinc hydroxide, zinc nitride, zinc oxide, zinc phosphate, zinc sulphide, zinc stannate, zinc hydroxystannate, basic zinc silicate, tin oxide hydrate and combinations thereof.

9. The polyamide moulding compound according to claim 1, wherein the at least one flame retardant is a phosphinic acid salt of the general formula (I) and/or formula (II) 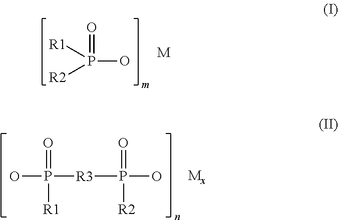
and/or one of the polymers thereof, R1 and R2 being the same or different and being selected from the group consisting of linear or branched C1-C8 alkyl and/or aryl, R3 being selected from the group consisting of linear or branched C1-C10 alkylene, C6-C, 10 arylene, alkylarylene and arylalkylene, M being a metal ion from the 2^{nd} or 3^{rd} main or subsidiary group of the periodic table m being 2 or 3, n 1 or 3, and x 1 or 2.

10. The polyamide moulding compound according to claim 1, wherein 5 to 24% by weight of the at least one flame retardant is contained in the polyamide moulding compound.

11. The polyamide moulding compound according to claim 1, wherein the at least one additive is selected from the group consisting of
light stabilisers, UV stabilisers, UV absorbers or UV blockers,
lubricants,
colourants,
nucleation agents,
antistatic agents
conductivity additives,
mould-release agents,
fillers
reinforcing agents,
optical brighteners and
mixtures thereof.

12. The polyamide moulding compound according claim 11, wherein fibres are contained as reinforcing agents.

13. The polyamide moulding compound according to claim 12, wherein the fibres concern fibres with a circular cross-sectional area, fibres with a non-circular cross-sectional area or a mixture of fibres with a circular cross-sectional area and fibres with a non-circular cross-sectional area, the proportion of fibres with a non-circular cross-sectional area in the mixture being at least 50% by weight and, in the case of the fibres with the non-circular cross-sectional area, the dimensional ratio of the main cross-sectional axis to the subsidiary cross-sectional axis being >2.

14. The polyamide moulding compound according to claim 12, wherein the fibres are short fibres, with a length in the range of 2 to 50 mm and a diameter of 5 to 40 μm, and/or endless fibres.

15. The polyamide moulding compound according to claim 1, wherein said moulding is free of metallic pigments.

16. A moulded article produced from a polyamide moulding compound according to claim 1, wherein the moulded article is a component for the automobile or electrical/electronic field.

17. The polyamide moulding compound according to claim 6, wherein the stabilisers based on secondary aromatic amines are selected from adducts of phenylenediamine with acetone, adducts of phenylenediamine with linolene, N,N′-dinaphthyl-p-phenylenediamine, N-phenyl-N′-cyclohexyl-p-phenylenediamine or mixtures of two or more thereof,
and the phosphite and phosphonate stabilizers are selected from triphenylphosphite, diphenylalkylphosphite, phenyldialkylphosphite, tris(nonylphenyl)phosphite, trilaurylphosphite, trioctadecylphosphite, distearylpentaerythritoldiphosphite, tris(2,4-di-tert-butylphenyl)phosphite, diisodecylpentaerythritoldiphosphite, bis(2,4-di-tert-butylphenyl)pentaerythritoldiphosphite, bis(2,6-di-tert-butyl-4-methylphenyl)-pentaerythritoldiphospite, diisodecyloxypentaerythritoldiphospite, bis(2,4-di-tert-butyl-6-methylphenyl)pentaerythritoldiphosphite, bis(2,4,6-tris-(tert-butylphenyl))pentaerythritoldiphosphite, tristearylsorbitoltriphosphite, tetrakis(2,4-di-tert-butylphenyl)-4,4′-biphenylenediphosphonite, 6-isooctyloxy-2,4,8,10-tetra-tert-butyl-12H-dibenz-[d,g]-1,3,2-dioxaphosphocine, 6-fluoro-2,4,8,10-tetra-tert-butyl-12-methyl-dibenz[d,g]-1,3,2-dioxaphosphocine, bis(2,4-di-tert-butyl-6-methylphenyl)methylphosphite and bis(2,4-di-tert-butyl-6-methylphenyl)ethylphosphite, tris[2-tert-butyl-4-thio(2′-methyl-4′-hydroxy-5′-tert-butyl)-phenyl-5-methyl]phenyl-phosphite and tris(2,4-di-tert-butylphenyl)phosphite, 2,6-di-tert-butyl-4-(4,6-bis(octylthio)-1,3,5-triazian-2-ylamino)phenol, triethyleneglycol bis(3-tert-butyl-4-hydroxy-5-methylphenyl)propionate, tetrakis-methylene(3,5-di-tert-butyl-4-hydroxyhydrocinnamate)methane, 3-(3,5-di-tert-butyl-4-hydroxyphenyl)propionic acid, 2,2″-methylenebis-(6-tert-butyl-p-cresol)monoacrylate and mixtures thereof.

18. The polyamide moulding compound according to claim 11, wherein the antistatic agents are selected from carbon black, carbon nanotubes or mixtures thereof, and the fillers are selected from whiskers, talcum, mica, silicates, quartz, titanium dioxide, wollastonite, kaolin, silicic acids, magnesium carbonate, magnesium hydroxide, chalk, ground or precipitated calcium carbonate, lime, field spar, barium sulphate, glass balls, hollow glass balls, hollow-ball silicate fillers, natural layer silicates, synthetic layer silicates, and mixtures thereof.

19. The polyamide moulding compound according claim 12, wherein fibres contained as reinforcing agents are glass fibres and/or carbon fibres.

20. The moulded article according to claim 16, wherein the component for the automobile or electrical/electronic field is selected from cylinder head covers, engine covers, housings for charge coolers, charge cooler flaps, intake pipes, intake manifolds, connectors, gearwheels, fan impellers, cooling water boxes, housings or housing parts for heat exchangers, coolant coolers, charge coolers, thermostat, water pump, heating body, attachment parts, in the form of an electrical or electronic component, parts of jump start assistance points, a circuit board, a part of a circuit board, a housing component, a foil, a pipe, in particular in the form of a switch, a distributor, a relay, a resistor, a capacitor, a coil, a lamp, a diode, an LED, a transistor, a connector, a regulator, a store and a sensor.
